(19) United States
(12) Patent Application Publication
(10) Pub. No.: US 2012/0327443 A1
(43) Pub. Date: Dec. 27, 2012

(54) TERMINAL DEVICE CAPABLE OF REMOTELY OPERATING IMAGE FORMING APPARATUS, NON-TRANSITORY STORAGE MEDIUM STORING THEREIN COMPUTER-READABLE PROGRAM EXECUTED BY TERMINAL DEVICE, AND REMOTE OPERATION SYSTEM INCLUDING TERMINAL DEVICE

(75) Inventor: Masato FUJII, Nagaokakyo-shi (JP)

(73) Assignee: Konica Minolta Business Technologies, Inc., Chiyoda-ku (JP)

(21) Appl. No.: 13/494,396

(22) Filed: Jun. 12, 2012

(30) Foreign Application Priority Data
Jun. 27, 2011 (JP) 2011-141682

(51) Int. Cl. G06K 15/02

(52) U.S. Cl. 358/1.13

(57) ABSTRACT

An image forming apparatus is configured to output image data including a content to be displayed on an operation panel to a terminal device. The terminal device includes a display unit, a determination unit for determining whether a plurality of images can be displayed on the display unit based on first image data output from the image forming apparatus, a switching unit for issuing a switching command to switch the displayed content on the operation panel to the image forming apparatus in response to the determination that the plurality of images can be displayed, and for obtaining second image data different from the first image data subsequent to the switching command, the second image data being output from the image forming apparatus; and a controller for displaying the first image data and the second image data on the display unit.

This application is based on Japanese Patent Application No. 2011-141682 filed with the Japan Patent Office on Jun. 27, 2011, the entire content of which is hereby incorporated by reference.

### BACKGROUND OF THE INVENTION

1. Field of the Invention

The present invention relates to a terminal device capable of remotely operating an image forming apparatus, a non-transitory storage medium storing therein a computer-readable program executed by the terminal device, and a remote operation system including the terminal device.

2. Description of the Related Art

Conventionally, there has been proposed a technology of remotely operating various apparatuses. Recently various arrangements for implementing the remote operation are proposed with the progress of ICT (Information and Communication Technology) and the progress of various display devices.

For example, Japanese Laid-Open Patent Publication No. 2010-016734 discloses a configuration in which, when a plurality of screens are simultaneously displayed, an operation can easily be performed to each screen. More specifically, the configuration disclosed in Japanese Laid-Open Patent Publication No. 2010-016734 is directed to a remote controller of a display device. A display device (1) transmits information on a virtual screen, which corresponds to a real screen displayed on a display unit (13), to a remote controller (2). A display unit (22) of remote controller (2) displays the virtual screen, which includes the plurality of screens and corresponds to the real screen. A touch panel (22A) is provided on a display surface of display unit (22). When a user changes an icon screen of the virtual screen, display unit (22) transmits information on the changed virtual screen to display device (1). Display device (1) changes the display of the real screen in synchronization with the virtual screen.

The apparatus that becomes a target of the remote operation may include not only a television apparatus disclosed in Japanese Laid-Open Patent Publication No. 2010-016734 but also various business machines. For example, it is conceivable that an MFP (Multi-Functional Peripheral) is remotely operated.

It is conceivable that a dedicated terminal device is prepared as a device for performing the remote operation. However, a portable device, such as a mobile phone and a smartphone, which is owned by each user is used as a remote controller in the future. That is, an arrangement in which an operation panel mounted on the MFP is replaced with the portable device owned by each user is under consideration.

When the remote operation arrangement is considered, in order to minimize a modification or a change on the MFP side, preferably a content (image data) that is generated in the MFP and displayed on the operation panel is directly transferred to the portable device through a network, and the content is displayed on the portable device. Advantageously the modification and change on the MFP side can be minimized by adopting the method, and the user can directly use the routinely used operation screen.

Resolution of a display of the portable device, such as the mobile phone and the smartphone, is increased with the advancement of technology, and some portable devices include the display having a screen size (the number of pixels) exceeding that of the operation panel mounted on the MFP. Therefore, when the contents displayed on the operation panel is directly displayed on the display of the portable device, performance of the display of the portable device is insufficiently exerted.

There is a need to simultaneously display a plurality of screen contents displayed on the operation panel by the use of the portable device. For example, there is a need to display some sort of operation screen and a corresponding help screen on the same display. The display enables the user to enhance operation performance.

On the other hand, in the method for directly transferring the content (image data) that is generated in the MFP and displayed on the operation panel to the portable device, it is necessary to provide some sort of new mechanism that displays the plurality of contents. Generally, because the operation panel is designed to display one screen at a given time, it is necessary to change the design of the MFP in order to change the configuration of the operation panel. However, it is not originally necessary to display the plurality of screen contents as the display in the operation panel.

Some portable devices have not-too-high display performance. In such portable devices, sometimes suitably the content displayed on the operation panel is directly output.

### SUMMARY OF THE INVENTION

An object of the present invention is to provide a terminal device that can perform the remote operation depending on the display performance without changing the MFP side, a non-transitory storage medium storing therein the computer-readable program executed by the terminal device, and a remote operation system including the terminal device.

According to an aspect of the present invention, there is provided a terminal device capable of remotely operating an image forming apparatus including an operation panel. The image forming apparatus is configured to output image data including a content to be displayed on the operation panel to the terminal device. The terminal device includes a display unit, a determination unit for determining whether a plurality of images can be displayed on the display unit based on first image data output from the image forming apparatus, a switching unit for issuing a switching command to switch the displayed content on the operation panel to the image forming apparatus in response to the determination that the plurality of images can be displayed, and for obtaining second image data different from the first image data subsequent to the switching command, the second image data being output from the image forming apparatus, and a controller for displaying the first image data and the second image data on the display unit.

Preferably, the controller displays the first image data in a first display area, displays the second image data in a second display area, and maintains the displayed content on the first or second display area until the first or second image data is newly obtained.

Preferably, the terminal device further includes an operation unit for issuing a corresponding operation command to the image forming apparatus in response to a user operation to the first or second display area.

More preferably, the operation command includes a command to display a content corresponding to the display area, which becomes a user operation target, in the operation panel.

Preferably, the controller obtains the second image data even if the plurality of images cannot be displayed, and displays the second image data while overlapping the second image data on the first image data.

Preferably, the controller stores the first image data and the second image data while correlating the first image data and the second image data with each other, and displays the stored second image data without newly obtaining second image data from the image forming apparatus, when a command to display the first image data is issued and the second image data correlated with the first image data of the command is already stored.

According to another aspect of the present invention, there is provided a non-transitory storage medium storing therein a computer-readable program for remotely operating an image forming apparatus including an operation panel. The program, when executed by a computer including a display unit, causes the computer to determine whether a plurality of images can be displayed on the display unit based on first image data output from the image forming apparatus. The image forming apparatus outputs image data including a content to be displayed on the operation panel to the computer. The program further causes the computer to issue a switching command to switch the displayed content on the operation panel to the image forming apparatus in response to the determination that the plurality of images can be displayed, to obtain second image data different from the first image data subsequent to the switching command, the second image data being output from the image forming apparatus; and to display the first image data and the second image data on the display unit.

Preferably, the step of displaying includes the steps of displaying the first image data in a first display area, displaying the second image data in a second display area, and maintaining the displayed content on the first or second display area until the first or second image data is newly obtained.

More preferably, the program further causes the computer to perform the step of issuing a corresponding operation command to the image forming apparatus in response to a user operation to the first or second display area.

More preferably, the operation command includes a command to display a content corresponding to the display area, which becomes a user operation target, in the operation panel.

Preferably, the step of displaying includes the step of obtaining the second image data even if the plurality of images cannot be displayed, and displaying the second image data while overlapping the second image data on the first image data.

Preferably, the step of displaying includes the steps of storing the first image data and the second image data while correlating the first image data and the second image data with each other, and displaying the stored second image data without newly obtaining second image data from the image forming apparatus, a command to display the first image data is issued and the second image data correlated with the first image data of the command is already stored.

A remote operation system according to still another aspect of the present invention includes an image forming apparatus having an operation panel, and a terminal device capable of remotely operating the image forming apparatus. The image forming apparatus outputs image data including a content to be displayed on the operation panel. The terminal device includes a display unit, a determination unit for determining whether a plurality of images can be displayed on the display unit based on first image data output from the image forming apparatus, a switching unit for issuing a switching command to switch the displayed content on the operation panel to the image forming apparatus in response to the determination that the plurality of images can be displayed, and for obtaining second image data different from the first image data subsequent to the switching command, the second image data being output from the image forming apparatus, and a controller for displaying the first image data and the second image data on the display unit.

Preferably, the controller displays the first image data in a first display area, displays the second image data in a second display area, and maintains the displayed content on the first or second display area until the first or second image data is newly obtained.

Preferably, the terminal device further includes an operation unit for issuing a corresponding operation command to the image forming apparatus in response to a user operation to the first or second display area.

More preferably, the operation command includes a command to display a content corresponding to the display area, which becomes a user operation target, in the operation panel.

Preferably, the controller obtains the second image data even if the plurality of images cannot be displayed, and displays the second image data while overlapping the second image data on the first image data.

Preferably, the controller stores the first image data and the second image data while correlating the first image data and the second image data with each other, and displays the stored second image data without newly obtaining second image data from the image forming apparatus when the correlated second image data is stored in issuing a command to display the first image data.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram illustrating an entire configuration including a terminal device according to an embodiment of the invention.

FIG. 2 is a schematic diagram illustrating a configuration of an MFP (Multi-Functional Peripheral) operated by the terminal device according to the embodiment.

FIG. 3 is a schematic diagram illustrating a configuration of the terminal device according to the embodiment.

FIG. 4 is an appearance view illustrating an operation panel of the MFP operated by the terminal device according to the embodiment.

FIG. 5 is a schematic diagram illustrating an internal data exchange of the MFP operated by the terminal device according to the embodiment.

FIG. 6 is a view illustrating an example of a user interface (multiscreen simultaneous display mode) provided in the terminal device according to the embodiment.

FIG. 7 is a view illustrating an example of a user interface (pop-up display mode) provided in the terminal device according to the embodiment.

FIG. 8 is a flowchart illustrating an entire processing procedure in the terminal device according to the embodiment.

FIGS. 9 and 10 are views illustrating update examples of a user interface screen provided by the terminal device according to the embodiment.

FIG. 11 is a sequence diagram illustrating an initial procedure when the terminal device according to the embodiment operates in the multiscreen simultaneous display mode.

FIG. 12 is a sequence diagram illustrating an operation/screen update procedure when the terminal device according to the embodiment operates in the multiscreen simultaneous display mode.

FIG. 13 is a sequence diagram illustrating a procedure when a user issues a command of pop-up display while the terminal device according to the embodiment operates in the pop-up display mode.

FIG. 14 is a sequence diagram illustrating a procedure when the user operates a help screen displayed in a sub-display area in the terminal device according to the embodiment.

FIG. 15 is a view illustrating a correspondence between an operation screen and a help screen according to a modification of the embodiment.

FIG. 16 is a flowchart illustrating a main part of an entire processing procedure in a terminal device according to the modification of the embodiment.

### DESCRIPTION OF THE PREFERRED EMBODIMENTS

Hereinafter, an embodiment of the invention will be described in detail with reference to the drawings. In the drawings, the identical or equivalent component is designated by the identical numeral, and the overlapping description is omitted.

<A. Entire Configuration>

An entire configuration including a terminal device according to an embodiment will be described.

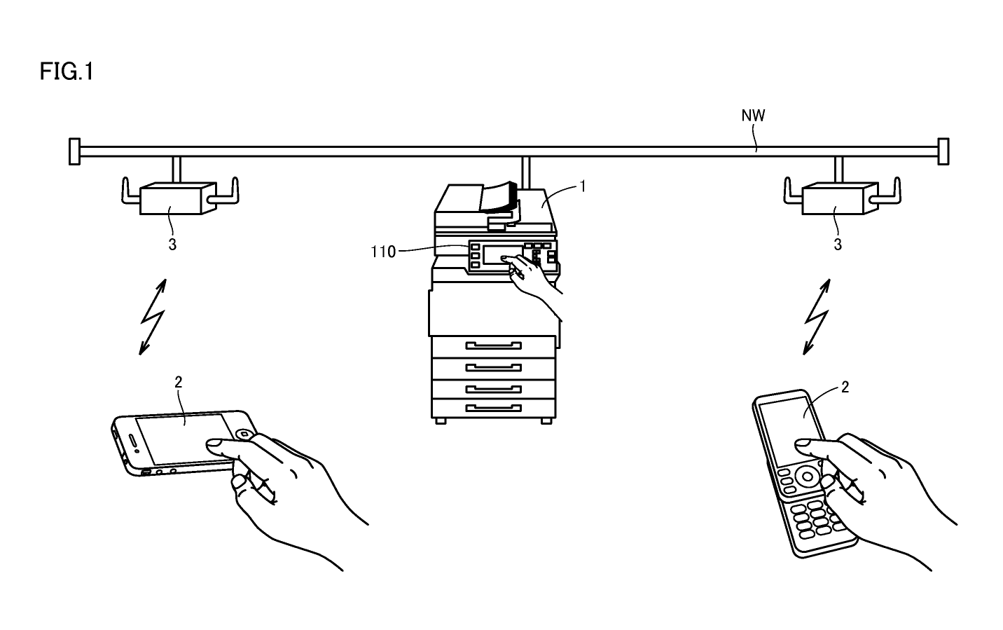

FIG. 1 is a schematic diagram illustrating the entire configuration including the terminal device according to the embodiment. Referring to FIG. 1, it is assumed that a multi-functional peripheral (hereinafter also abbreviated to an “MFP”) connected to a network NW is disposed. It is assumed that a wireless repeater 3 that exchanges data with a terminal device 2 by wireless communication (typically, a wireless LAN or Bluetooth® is connected to network NW.

An operation panel 110 is provided in an MFP 1 in order to perform various operations, and a user operates operation panel 110 to issue various commands to MFP 1.

Typically, terminal device 2 is a mobile phone or a smartphone, which is owned by the user. The user operates MFP 1 by means of operating terminal device 2 owned by the user. In each terminal device 2, an operation screen is displayed on operation panel 110 in a display mode suitable for terminal device 2. The user issues various commands to MFP 1 in the same manner as the operation of operation panel 110 of MFP 1.

Therefore, the user can operate MFP 1 in a position distant from MFP 1.

<B. Configuration of MFP 1>

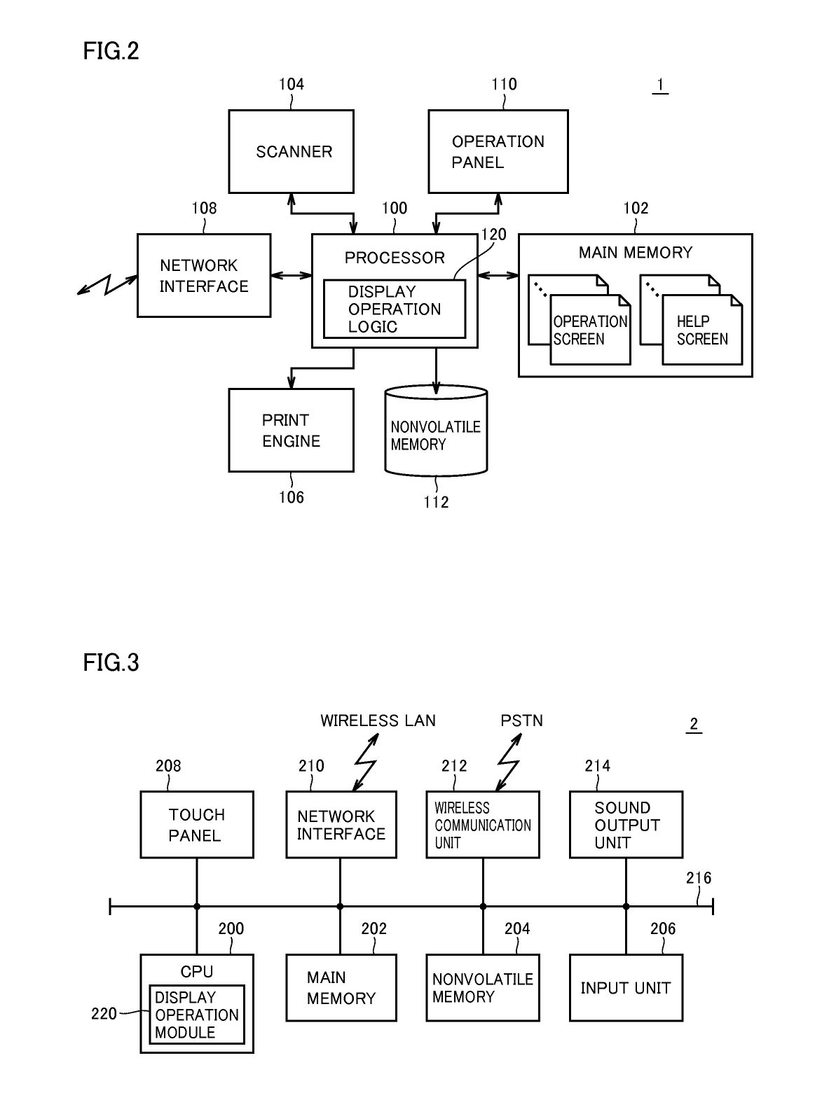

A configuration of MFP 1 in FIG. 1 will be described below. FIG. 2 is a schematic diagram illustrating the configuration of MFP 1 operated by terminal device 2 according to the embodiment.

Referring to FIG. 2, MFP 1 includes a processor 100, a main memory 102, a scanner 104, a print engine 106, a network interface (I/F) 108, an operation panel 110, and a nonvolatile memory 112.

Representatively, processor 100 is configured to include a processing device, such as a CPU (Central Processing Unit), and performs processing according to the embodiment by executing a stored computer-readable program in advance. More specifically, in processor 100, the program is executed to implement display operation logic 120, thereby providing the later-described processing.

Representatively, main memory 102 is a volatile storage device, such as a DRAM (Dynamic Random Access Memory). For example, main memory 102 retains the program executed by processor 100 and data necessary to execute the program.

Representatively, nonvolatile memory 112 includes a storage device, such as a hard disk drive and a flash memory. For example, the operation screen displayed on operation panel 110, attribute information associated with the operation screen, and customized information set by the user are stored in nonvolatile memory 112.

Representatively, network interface 108 is a communication unit that transmits and receives the data to and from terminal device 2 (FIG. 1) via network NW. For example, network interface 108 includes a LAN adapter and driver software controlling the LAN adapter. Print engine 106 performs printing processing and includes a control device that controls actuation of each unit in addition to a hardware configuration relating to the printing processing.

Operation panel 110 is a man-machine interface, which presents various pieces of information to the user while receiving the operation from the user. More specifically, operation panel 110 includes a touch panel (a display and a pressure-sensitive unit) and various operation keys.

<C. Configuration of Terminal Device 2>

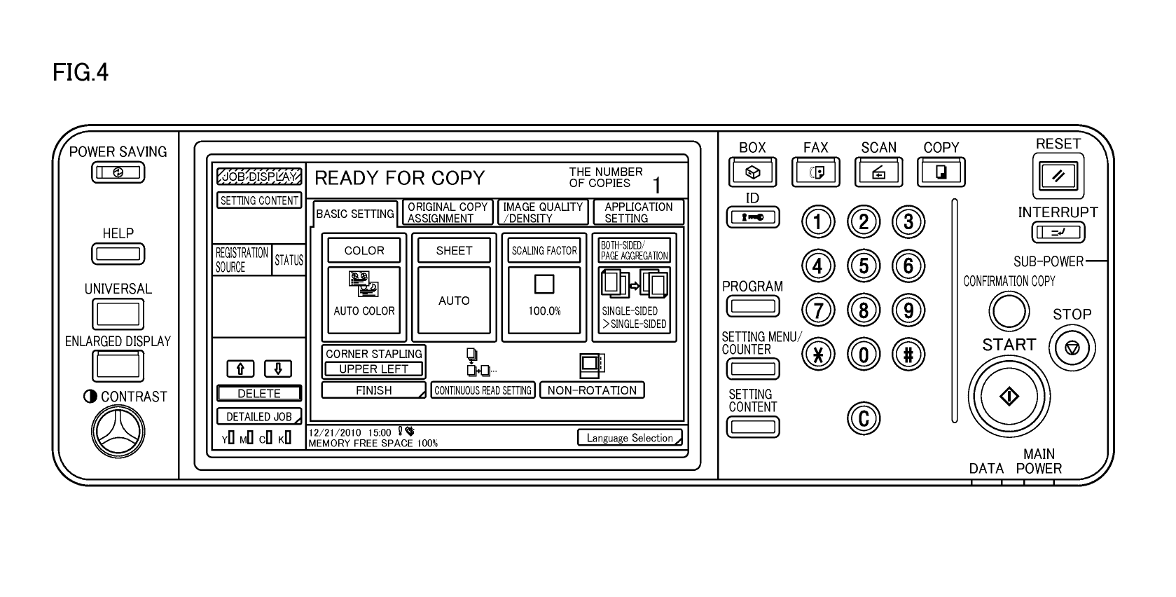

A configuration of terminal device 2 in FIG. 1 will be described below. FIG. 3 is a schematic diagram illustrating the configuration of terminal device 2 according to the embodiment.

Referring to FIG. 3, terminal device 2 is a computer that includes a CPU 200, a main memory 202, a nonvolatile memory 204, an input unit 206, a touch panel 208, a network interface 210, a wireless communication unit 212, and sound output unit 214. These components are connected to one another through bus 216.

CPU 200 executes various computer-readable programs including an operating system. Terminal device 2 may be configured to operate under a general-purpose operating system. Main memory 202 acts as a working memory, which is used when CPU 200 executes the program, and temporarily retains the expanded program for the execution and various variables necessary for the execution. Typically, nonvolatile memory 204 includes a hard disk or a flash memory to store the program executed by CPU 200.

Input unit 206 includes a key group disposed in a surface of terminal device 2, and receives the user operation. Touch panel 208 that is of the display unit displays various pieces of information that should be presented to the user in response to the command from CPU 200, and issues a command corresponding to the user operation to CPU 200.

Network interface 210 exchanges the data with various instruments including MFP 1 through wireless repeater 3 (FIG. 1). Wireless communication unit 212 includes a transmitting/receiving circuit that conducts wide-area communication via PSTN.

Typically, sound output unit 214 is a speaker that provides various pieces of sound information to the user.

Typically, CPU 200 executes the program to dynamically generate display operation module 220, thereby providing functions of remotely operating image forming apparatus 1 including operation panel 110. The program providing display operation module 220 is previously installed in non-transitory nonvolatile memory 204. Alternatively the program may be installed by various known methods.

A method for installing the program in terminal device 2 through the non-transitory storage medium, such as a CD-ROM (Compact Disk-Read Only Memory) and a flash memory, and a method for distributing the program to terminal device 2 via the network can be cited.

A program implementing the remote operation may be downloaded from MFP 1 to terminal device 2. In this case, various programs can be provided to terminal device 2 according to a type of MFP 1, and processing depending on the type can easily be dealt with.

Terminal device 2 may be constructed as a personal computer in which a general-purpose architecture is used.

<D. Operation Panel 110 and Internal Data Exchange>

An outline of operation panel 110 of MFP 1 and a data exchange with terminal device 2 according to the embodiment will be described below.

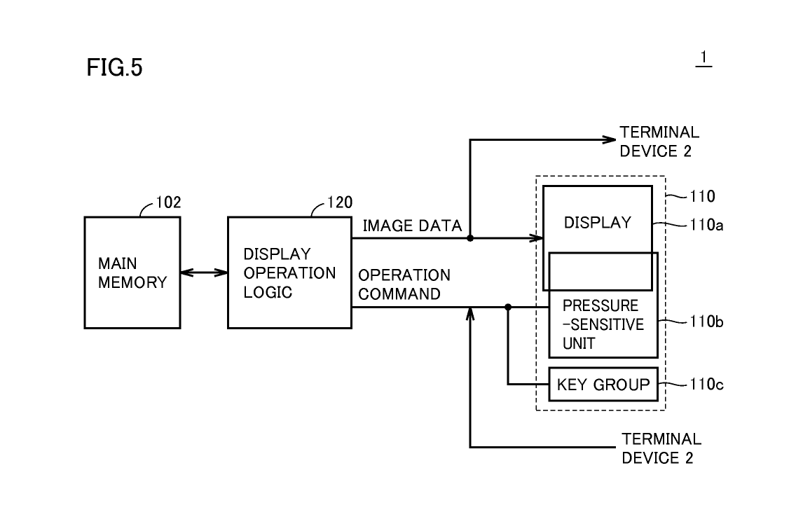

FIG. 4 is an appearance view illustrating operation panel 110 of MFP 1 operated by terminal device 2 according to the embodiment. Referring to FIG. 4, a touch panel, which is of the display unit and the operation unit, is provided in the substantial center of operation panel 110, and the key groups that are of the operation unit are provided on both sides of the touch panel. The operation screen used to operate MFP 1 is displayed on the touch panel. One operation screen is always displayed on operation panel 110 of MFP 1. In the operation screen, objects (icons) for operation are disposed such that the user can perform touch operation while various pieces of information are displayed. When the user touches one of the operation objects, a corresponding command is internally issued to perform a transition to another operation screen or various setting operations.

MFP 1 is configured to directly output image data containing a content to be displayed on operation panel 110 to terminal device 2. MFP 1 is also configured to receive commands from terminal device 2.

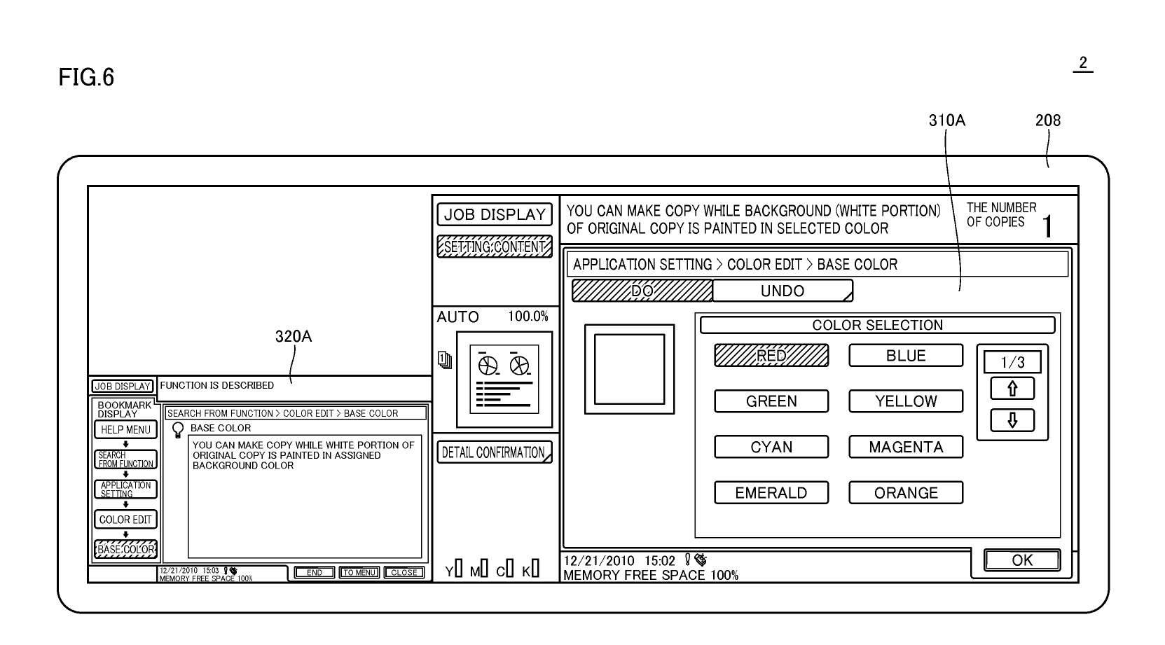

FIG. 5 is a schematic diagram illustrating an internal data exchange of MFP 1 operated by terminal device 2 according to the embodiment. Referring to FIG. 5, display operation logic 120 (FIG. 2) refers to the operation screen data stored in main memory 102 to output the image data to the touch panel (display 110a) of operation panel 110. In response to the user operation of the touch panel (a pressure-sensitive unit 110b or a key group 110c) of operation panel 110, display operation logic 120 receives a corresponding operation command. According to the operation command, display operation logic 120 properly updates the operation screen displayed on operation panel 110, or issues various internal commands.

The image data output from display operation logic 120 to operation panel 110 is output to terminal device 2 in a paratactic manner. That is, display operation logic 120 can output the image data to both operation panel 110 and terminal device 2. The image data is transmitted from display operation logic 120 to terminal device 2 through network interface 108 (FIG. 2).

An operation command from terminal device 2 can (logically) be superimposed on a transmission route of the operation command from operation panel 110 to display operation logic 120. That is, in addition to the operation command issued by the user operation of operation panel 110, display operation logic 120 receives the operation command issued by the user operation of terminal device 2 without any distinction. Therefore, terminal device 2 can issue the same operation command as with the user operation of operation panel 110 by emulating the internal command issued by operation panel 110.

<E. User Interface Provided by Terminal Device 2>

A user interface provided in terminal device 2 according to the embodiment will be described below.

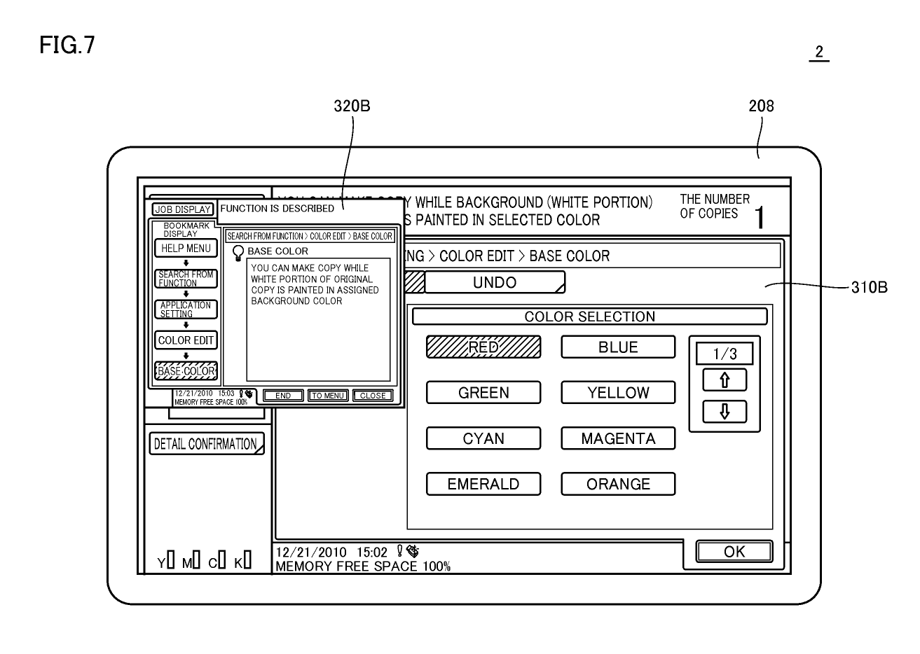

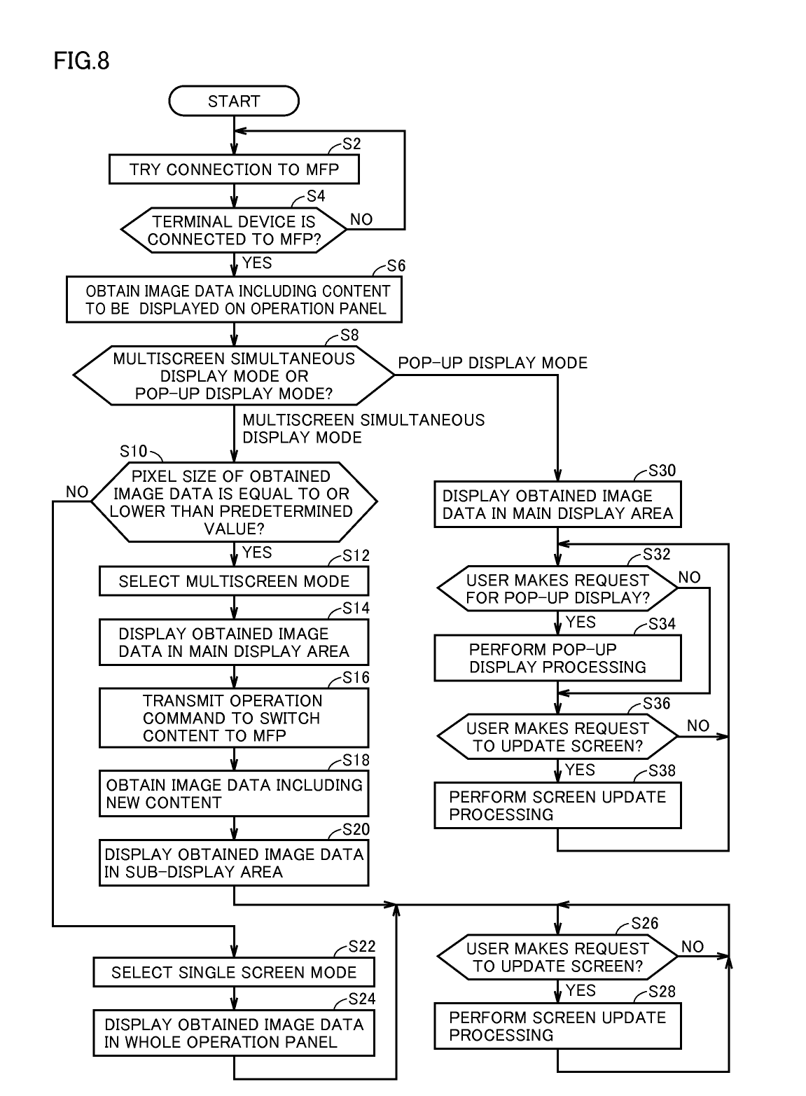

FIG. 6 is a view illustrating an example of the user interface (multiscreen simultaneous display mode) provided in terminal device 2 according to the embodiment. FIG. 7 is a view illustrating an example of the user interface (pop-up display mode) provided in terminal device 2 according to the embodiment.

FIGS. 6 and 7 illustrate examples in which a plurality of operation screens displayed on operation panel 110 are displayed on terminal device 2. The case that a screen used to perform some sort of operation and a help screen used to assist the operation in the screen are displayed is conceivable as a typical example of the case that the plurality of operation screens are displayed.

More specifically, FIGS. 6 and 7 illustrate the examples in which an operation screen relating to functions of performing printing processing after a background (white portion) of an original copy is painted in a selected color and the help screen corresponding to the operation screen are simultaneously displayed.

FIG. 6 illustrates the example of a mode in which the plurality of screens are displayed side by side in a main display area 310A and a sub-display area 320A while not overlapped with each other. That is, in the multiscreen simultaneous display mode in FIG. 6, the operation screen on operation panel 110 and the help screen are always displayed in main display area 310A and sub-display area 320A, respectively. When the user operates the operation screen in main display area 310A to make the transition to another operation screen, the help screen in sub-display area 320A also makes the transition in synchronization with the operation screen of the transition destination.

On the other hand, FIG. 7 illustrates the example of a mode in which, although the plurality of screens are displayed in a main display area 310B and a sub-display area 320B, main display area 310B and sub-display area 320B are displayed while overlapped with each other. Usually only the operation screen of operation panel 110 is displayed in the pop-up display mode in FIG. 7. When the user performs a predetermined operation to call up the help screen, the help screen is displayed as a pop-up window in a form in which the help screen is overlay-displayed on the operation screen in main display area 310B.

Thus, touch panel 208 that is of display means of terminal device 2 displays the image data (operation screen) illustrating the content on the operation panel in first display area (display area 310A or 310B), and displays image data (help screen) illustrating another content on the operation panel in second display area (display area 320A or 320B).

The user can arbitrarily select the display modes illustrated in FIGS. 6 and 7. However, in the multiscreen simultaneous display mode, sometimes an adequate arrangement cannot be implemented depending on a relationship between an image size (or resolution) of touch panel 208 and a size (or resolution) of the image data displayed on operation panel 110. In the example in FIG. 6, the resolution of touch panel 208 of terminal device 2 is sufficiently larger than the image size displayed on operation panel 110, so that the plurality of display areas can be disposed so as not to be overlapped with each other (at least three display areas may be displayed). On the other hand, as illustrated in FIG. 7, when the resolution of touch panel 208 of terminal device 2 is insufficiently larger than the image size displayed on operation panel 110, it is difficult that the plurality of display areas are disposed so as not to be overlapped with each other. When the plurality of display areas are disposed so as not to be overlapped with each other, the size of a character is excessively reduced as a result of resizing, and sometimes it is difficult to visually recognize the content. In such cases, the mode in which only the single operation screen is displayed or the pop-up display in FIG. 7 is suitably performed.

In terminal device 2 according to the embodiment, the display mode is determined based on one of the pieces of image data output from operation panel 110 of MFP 1, and the received image data is displayed on touch panel 208 in the determined display mode.

As illustrated in FIGS. 6 and 7, the examples in which the multiscreen simultaneous display mode and the pop-up display mode can be selected is described below. Alternatively, a display mode except the multiscreen simultaneous display mode and the pop-up display mode may be adopted, or another display mode may be added.

<F. Processing Procedure>

(f1: Entire Processing Procedure)

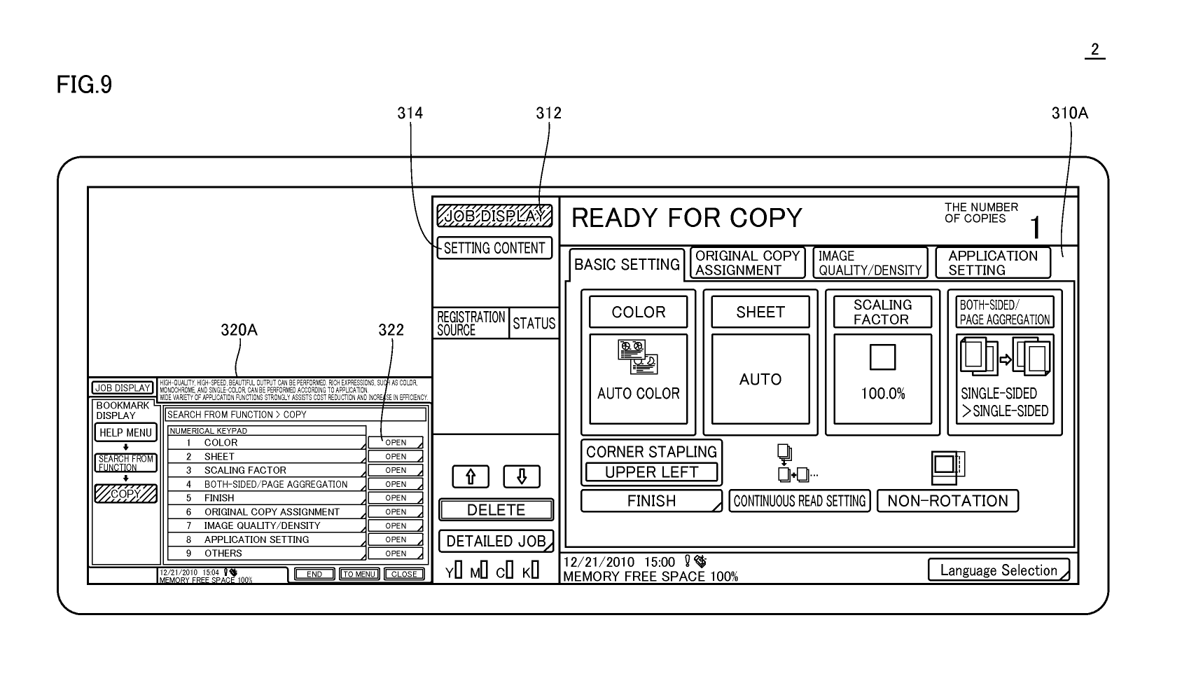

An entire processing procedure in terminal device 2 according to the embodiment will be described. FIG. 8 is a flowchart illustrating the entire processing procedure in terminal device 2 according to the embodiment. Typically, each step in FIG. 8 is performed such that CPU 200 executes the program. That is, each step in FIG. 8 corresponds to the function(s) provided by display operation module 220.

Referring to FIG. 8, the following processing is started when the user operates terminal device 2 to start the program relating to the remote operation according to the embodiment. Terminal device 2 activates network interface 210 (FIG. 3) to try connection to MFP 1 (Step S2). Terminal device 2 determines whether terminal device 2 is connected to MFP 1 (Step S4). When terminal device 2 is not connected to MFP 1 (NO in Step S4), the pieces of processing in Steps S2 and S4 are repeated.

When terminal device 2 is connected to MFP 1 (YES in Step S4), terminal device 2 obtains image data including a content to be displayed on operation panel 110 at that time from MFP 1 (Step S6).

Then terminal device 2 receives the user selection of the multiscreen simultaneous display mode and the pop-up display mode (Step S8). When the multiscreen simultaneous display mode is selected (for the “multiscreen simultaneous display mode” in Step S8), pieces of processing from Step S10 are performed. On the other hand, when the pop-up display mode is selected (for the “pop-up display mode” in Step S8), pieces of processing from Step S30 are performed.

When the multiscreen simultaneous display mode is selected, terminal device 2 determines the display mode based on an attribute of the obtained image data. That is, CPU 200 (display operation module 220) of terminal device 2 determines whether the plurality of images can be displayed on touch panel 208 based on the image data (or operation screen) output from image forming apparatus 1. More specifically, terminal device 2 determines whether a pixel size of the obtained image data is equal to or lower than a predetermined value (Step S10).

When the pixel size of the obtained image data is equal to or lower than a predetermined value (YES in Step S10), terminal device 2 determines that the multiscreen simultaneous display mode can be performed, and selects a multiscreen mode (Step S12). Terminal device 2 displays the obtained image data in the main display area (Step S14).

Terminal device 2 transmits the operation command to switch the displayed content on operation panel 110 to a new content associated with the displayed content at that time to MFP 1 (Step S16). Terminal device 2 obtains the image data including a new content to be displayed on operation panel 110 from MFP 1 (Step S18). Terminal device 2 displays the obtained image data in the sub-display area (Step S20).

Thus, CPU 200 (display operation module 220) of terminal device 2 issues the switching command to switch the displayed content on operation panel 110 to image forming apparatus 1 in response to the determination that the plurality of images can be displayed on touch panel 208, and obtains image data (e.g. help screen) different from the image data output from image forming apparatus 1 in response to the switching signal. CPU 200 (display operation module 220) of terminal device 2 displays the obtained two pieces of image data (the operation screen and the help screen) on touch panel 208.

On the other hand, when the pixel size of the obtained image data is larger than the predetermined value (NO in Step S10), terminal device 2 determines that the plurality of operation screens cannot simultaneously be displayed, and selects a single screen mode (Step S22). Terminal device 2 displays the obtained image data in the whole area of touch panel 208 (Step S24).

Then terminal device 2 determines whether the user makes a request to update the screen (Step S26). When the user does not make the request to update the screen (NO in Step S26), the processing in Step S26 is repeated.

On the other hand, when the user makes the request to update the screen (YES in Step S26), terminal device 2 performs screen update processing (Step S28). The screen update processing is performed according to the selected mode (the single screen mode or the multiscreen mode). The processing in Step S26 is repeated until the user issues an ending command.

When the pop-up display mode is selected, terminal device 2 displays the obtained image data in the main display area (Step S30). Then terminal device 2 determines whether the user makes a request for the pop-up display (Step S32).

When the user makes the request for the pop-up display (YES in Step S32), terminal device 2 performs pop-up display processing (Step S34). On the other hand, when the user does not make the request for the pop-up display (NO in Step S32), the processing in Step S34 is skipped.

Then terminal device 2 determines whether the user makes the request to update the screen (Step S36).

When the user makes the request to update the screen (NO in Step S36), terminal device 2 performs the screen update processing (Step S38). On the other hand, when the user does not make the request to update the screen (NO in Step S36), the processing in Step S38 is skipped.

The processing in Step S36 is repeated until the user issues the ending command.

When the user performs some sort of operation in the pieces of repetition processing in Steps S26 and S28 and the pieces of repetition processing in Steps S36 and S38, the corresponding operation command is transmitted to MFP 1.

As described above, in the multiscreen simultaneous display mode, the predetermined value (i.e. threshold) to which the pixel size is compared in checking the pixel size of the image data obtained from MFP 1 is determined in consideration of various factors. Because scaling display of the image data can be performed in terminal device 2, it is not necessary that the threshold used to select one of the multiscreen mode and the single screen mode be simply set to a display size of the terminal device. But the predetermined value that is of the threshold is determined in consideration of the factor of the easy-to-read size or the easy-to-operate size for the user.

(f2: Example of Screen Update)

An example of the screen update processing in FIG. 8 will be described below.

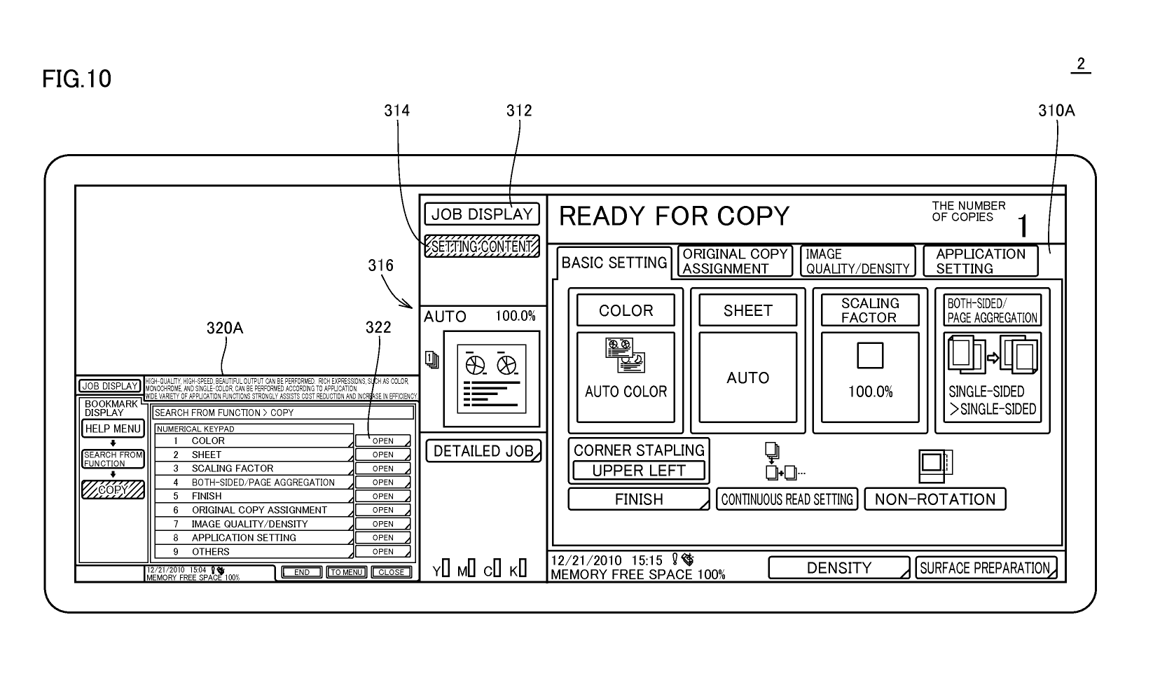

FIGS. 9 and 10 are views illustrating update examples of a user interface screen provided by terminal device 2 according to the embodiment.

Referring to FIGS. 9 and 10, for example, a button 312 issuing a command for displaying a detail of job(s) and a button 314 issuing a command for a setting content are illustrated in the operation screen (main display area 310A) in which the print operation is set in MFP 1.

In the state in which button 312 is active (FIG. 9), when the user operates terminal device 2 to select button 314, a transition to a screen (the numeral 316) in which the current setting content is displayed is made as illustrated in FIG. 10 similarly to the case that button 314 is selected on operation panel 110.

The same holds true for the operation of button 322 included in the help screen of display area 320B.

In terminal device 2 according to the embodiment, when the user operates touch panel 208, the same command as with the operation of operation panel 110 of MFP 1 is issued, and the screen content updated by the command is displayed on terminal device 2.

(f3: Initial Procedure in Multiscreen Simultaneous Display Mode)

An initial procedure in the multiscreen simultaneous display mode will be described below.

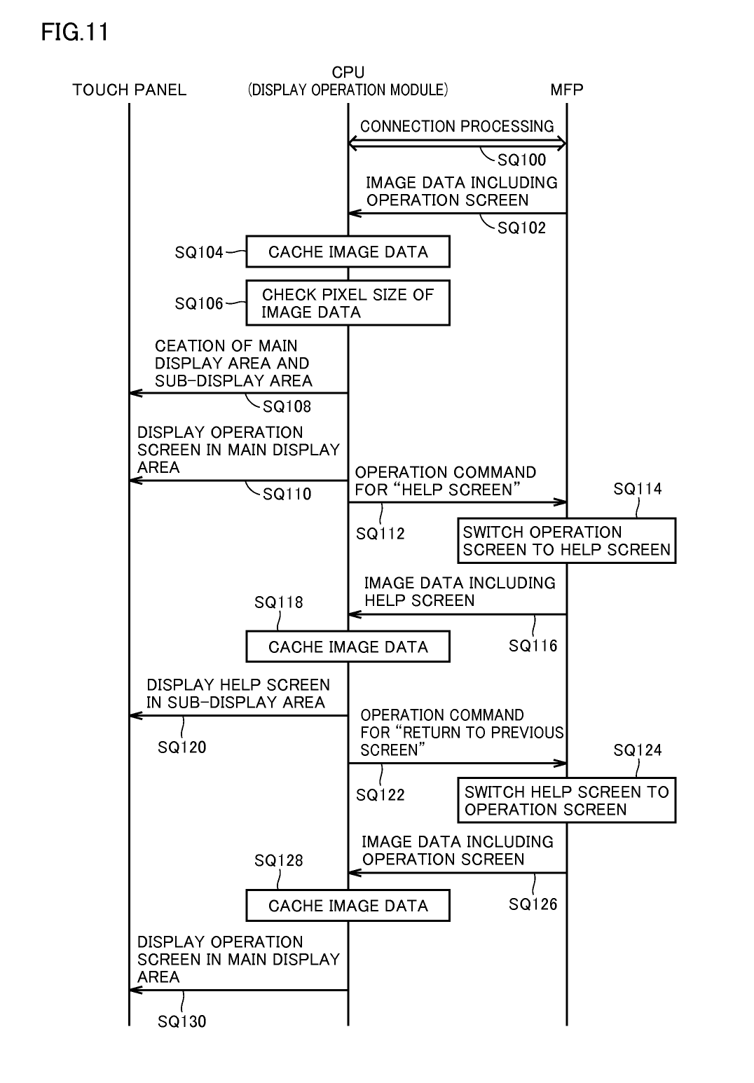

FIG. 11 is a sequence diagram illustrating the initial procedure when terminal device 2 according to the embodiment operates in the multiscreen simultaneous display mode. FIG. 11 illustrates the procedure example when the multiscreen mode can be displayed. However, the substantially same processing is performed, when only the single screen mode can be displayed while the multiscreen mode cannot be displayed. The initial procedure of the pop-up display mode is substantially identical to that in the case that only the single screen mode can be displayed.

In FIG. 11, the operation screen and the corresponding help screen are displayed on the same display side by side as a typical usage pattern.

Referring to FIG. 11, when the user starts the program relating to the remote operation according to the embodiment, CPU 200 of terminal device 2 starts processing of connecting to MFP 1 (Sequence SQ100). When the connection processing is completed, CPU 200 of terminal device 2 obtains the image data including a content to be displayed (e.g. operation screen) on operation panel 110 from MFP 1 (Sequence SQ102), and caches the obtained image data (Sequence SQ104).

Then CPU 200 of terminal device 2 checks the pixel size of the image data (Sequence SQ106). In the example in FIG. 11, it is assumed that the pixel size of the image data is equal to or lower than the predetermined value, and it is assumed that the determination that the multiscreen mode can be performed is made. CPU 200 of terminal device 2 creates the main display area and the sub-display area on touch panel 208 in order to display the multiscreen mode (Sequence SQ108). CPU 200 of terminal device 2 displays the obtained image data (operation screen) in the main display area on touch panel 208 (Sequence SQ110).

Then CPU 200 of terminal device 2 transmits the operation command to display the “help screen” to MFP 1 (Sequence SQ112). In response to the operation command to display the “help screen,” MFP 1 switches the displayed content on operation panel 110 from the operation screen to the help screen (Sequence SQ114). CPU 200 of terminal device 2 obtains the image data including a new content for replacing (e.g. help screen) on operation panel 110 from MFP 1 (Sequence SQ116), and caches the obtained image data (Sequence SQ118). Then CPU 200 of terminal device 2 displays the obtained image data (help screen) in the sub-display area on touch panel 208 (Sequence SQ120).

Then CPU 200 of terminal device 2 transmits the operation command to “return to the previous screen” to MFP 1 (Sequence SQ122). In response to the operation command to “return to the previous screen,” MFP 1 switches the displayed content on operation panel 110 from the help screen to the operation screen (Sequence SQ124). CPU 200 of terminal device 2 obtains the image data including the displayed content (operation screen) on operation panel 110 from MFP 1 after the screen returns to the original screen (Sequence SQ126), and caches the obtained image data (Sequence S128). Then CPU 200 of terminal device 2 displays the obtained image data (operation screen) in the main display area on touch panel 208 (Sequence SQ130). That is, CPU 200 of terminal device 2 updates the display in the main display area.

As described above, CPU 200 of terminal device 2 displays the image data of the operation screen in the main display area, displays the image data of the help screen in the sub-display area, and maintains the displayed contents in the main display area and the sub-display area until one of the pieces of image data is newly obtained.

(f4: Operation /Screen Update in Multiscreen Simultaneous Display Mode)

A operation procedure and a screen update procedure in the case that the user operates touch panel 208 with the plurality of screens (the operation screen and the help screen) displayed in the multiscreen simultaneous display mode will be described below.

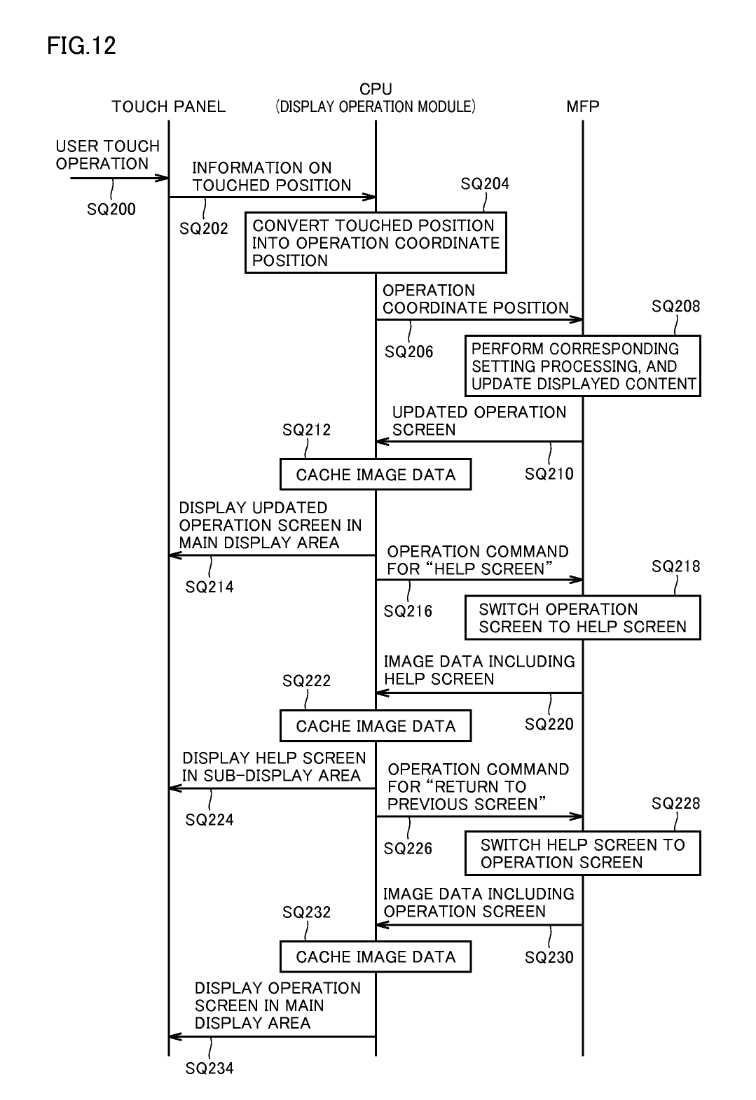

FIG. 12 is a sequence diagram illustrating the operation/screen update procedure when terminal device 2 according to the embodiment operates in the multiscreen simultaneous display mode. FIG. 12 illustrates the procedure example in the multiscreen mode. However, the substantially same processing is performed even in the single screen mode.

Referring to FIG. 12, when the user touches any one of positions on touch panel 208 (Sequence SQ200), information on the touched position is transmitted to CPU 200 of terminal device 2 (Sequence SQ202). Based on a relationship between the display position and the size of the displayed main display area, CPU 200 of terminal device 2 converts the position touched by the user into an operation coordinate position indicating which position is touched in the operation screen (Sequence SQ204). CPU 200 of terminal device 2 transmits the operation coordinate position to MFP 1 (Sequence SQ206). When receiving the operation coordinate position from terminal device 2, MFP 1 performs the corresponding setting processing while updating the displayed content on operation panel 110 according to the processing (Sequence SQ208). CPU 200 of terminal device 2 obtains the image data including a new content for replacing (i.e. updated operation screen) on operation panel 110 from MFP 1 (Sequence SQ210), and caches the obtained image data (Sequence SQ212). Then CPU 200 of terminal device 2 displays the obtained image data (updated operation screen) in the main display area on touch panel 208 (Sequence SQ214).

Then CPU 200 of terminal device 2 transmits the operation command to display the “help screen” to MFP 1 (Sequence SQ216). In response to the operation command to display the “help screen,” MFP 1 switches the displayed content on operation panel 110 from the operation screen to the help screen (Sequence SQ218). CPU 200 of terminal device 2 obtains the image data including a new content for replacing (e.g. help screen) on operation panel 110 from MFP 1 (Sequence SQ220), and CPU 200 caches the obtained image data (Sequence SQ222). Then CPU 200 of terminal device 2 displays the obtained image data (help screen) in the sub-display area on touch panel 208 (Sequence SQ224).

Then CPU 200 of terminal device 2 transmits the operation command to “return to the previous screen” to MFP 1 (Sequence SQ226). In response to the operation command to “return to the previous screen,” MFP 1 switches the displayed content on operation panel 110 from the help screen to the operation screen (Sequence SQ228). CPU 200 of terminal device 2 obtains the image data including the displayed content (e.g. operation screen) on operation panel 110 from MFP 1 after the screen returns to the original screen (Sequence SQ230), and caches the obtained image data (Sequence SQ232). Then CPU 200 of terminal device 2 displays the obtained image data (e.g. operation screen) in the main display area on touch panel 208 (Sequence SQ234). That is, CPU 200 of terminal device 2 updates the display in the main display area.

Thus, in response to the user operation to the main display area, CPU 200 of terminal device 2 issues the corresponding operation command to image forming apparatus 1. The operation command includes a command to display the content corresponding to the display area that becomes a target of the user operation on operation panel 110.

(f5: Pop-up Display Procedure in Pop-up Display Mode)

A display procedure in the case that the user issues the command for the pop-up display with the plurality of screens (the operation screen and the help screen) displayed in the pop-up display mode will be described below.

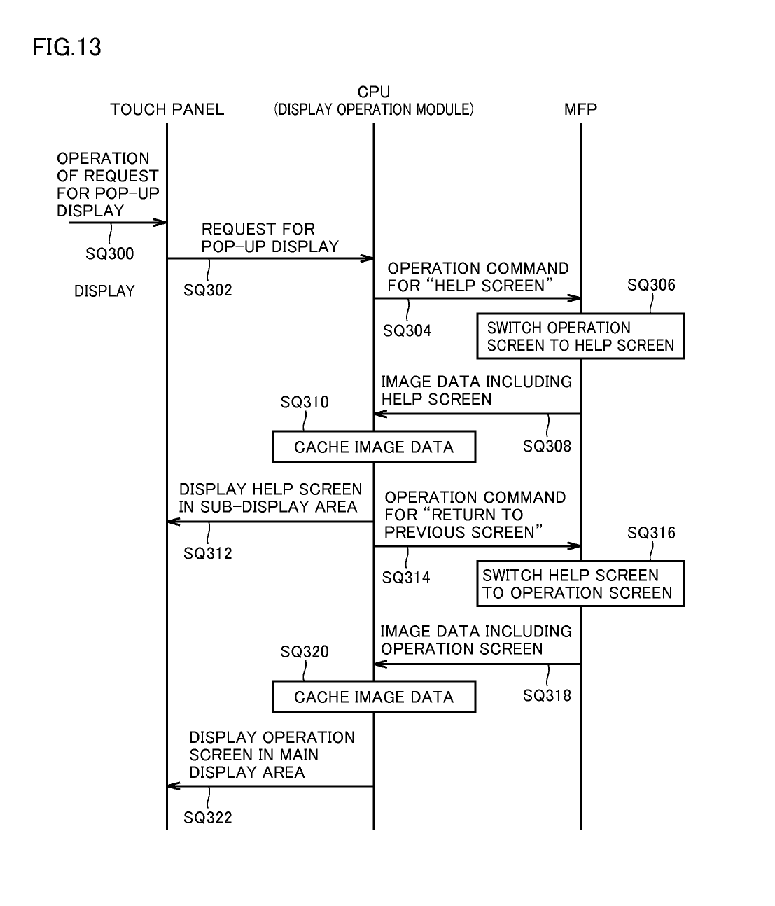

FIG. 13 is a sequence diagram illustrating a procedure when the user issues the command for the pop-up display while terminal device 2 according to the embodiment operates in the pop-up display mode.

Referring to FIG. 13, when the user touches touch panel 208 to make a request for the pop-up display (Sequence SQ300), the request for the pop-up display is transmitted to CPU 200 of terminal device 2 (Sequence SQ302). Then CPU 200 of terminal device 2 transmits the operation command to display the “help screen” to MFP 1 (Sequence SQ304). In response to the operation command to display the “help screen,” MFP 1 switches the displayed content on operation panel 110 from the operation screen to the help screen (Sequence SQ306). CPU 200 of terminal device 2 obtains the image data including a new content for replacing (e.g. help screen) on operation panel 110 from MFP 1 (Sequence SQ308), and caches the obtained image data (Sequence SQ310). Then CPU 200 of terminal device 2 displays the obtained image data (help screen) in the sub-display area on touch panel 208 (Sequence SQ312). The sub-display area is displayed as a pop-up window form, and overlay-displayed on the main display area.

Then CPU 200 of terminal device 2 transmits the operation command to “return to the previous screen” to MFP 1 (Sequence SQ314). In response to the operation command to “return to the previous screen,” MFP 1 switches the displayed content on operation panel 110 from the help screen to the operation screen (Sequence SQ316). CPU 200 of terminal device 2 obtains the image data including a content to be displayed (e.g. operation screen) on operation panel 110 from MFP 1 after the screen returns to the original screen (Sequence SQ318), and caches the obtained image data (Sequence SQ320). Then CPU 200 of terminal device 2 displays the obtained image data (e.g. operation screen) in the main display area on touch panel 208 (Sequence SQ320). That is, CPU 200 of terminal device 2 updates the display in the main display area.

Thus, even if the plurality of images cannot be displayed, CPU 200 of terminal device 2 obtains the image data corresponding to the help screen, and CPU 200 displays the help screen while overlapping the help screen on the operation screen.

(f6: Display Procedure of Operation to Sub-Display Area)

A processing procedure in the case that the user operates the help screen displayed in sub-display area in the multiscreen simultaneous display mode or the pop-up display mode will be described below.

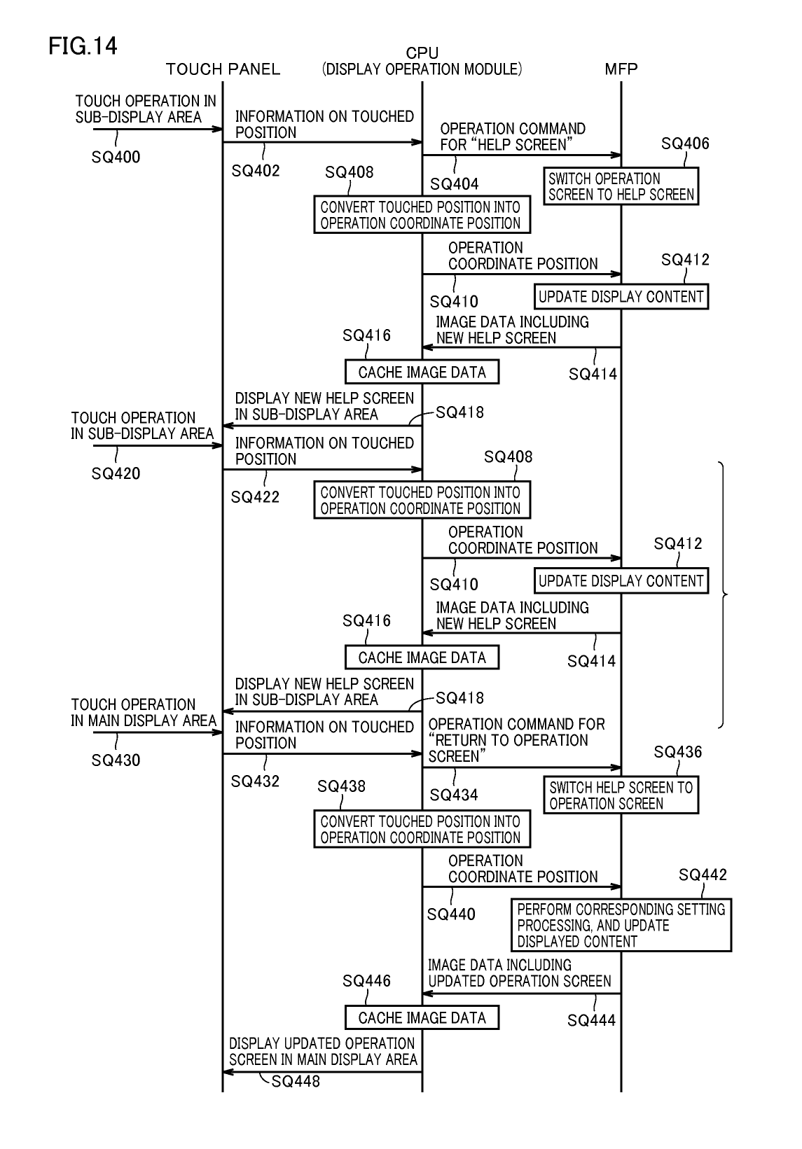

FIG. 14 is a sequence diagram illustrating a procedure when the user operates the help screen displayed in the sub-display area in terminal device 2 according to the embodiment. The sequence diagram in FIG. 14 can also be applied to both the case that the main display area and the sub-display area are displayed side by side in the multiscreen simultaneous display mode and the case that the sub-display area is overlay-displayed on the main display area in the pop-up display mode.

Referring to FIG. 14, when the user touches any one of positions in the sub-display area displayed on touch panel 208 (Sequence SQ400), information on the touched position is transmitted to CPU 200 of terminal device 2 (Sequence SQ402). CPU 200 of terminal device 2 determines that the position touched by the user is the sub-display area, and CPU 200 transmits the operation command to display the “help screen” to MFP 1 (Sequence SQ404). In response to the operation command to display the “help screen,” MFP 1 switches the displayed content on operation panel 110 from the operation screen to the help screen (Sequence SQ406). The processing in Sequence SQ406 is performed to ensure that the help screen is displayed on operation panel 110, because which operation screen is displayed is indeterminate on operation panel 110 of MFP 1.

Based on a relationship between the display position and the size of the displayed sub-display area, CPU 200 of terminal device 2 converts the position touched by the user into an operation coordinate position indicating which position is touched in the help screen (Sequence SQ408). CPU 200 of terminal device 2 transmits the operation coordinate position to MFP 1 (Sequence SQ410). When receiving the operation coordinate position from terminal device 2, MFP 1 updates the display content on operation panel 110 according to the operation coordinate position (Sequence SQ412). CPU 200 of terminal device 2 obtains the image data including a new content for replacing (e.g. new help screen) on operation panel 110 from MFP 1 (Sequence SQ414), and caches the obtained image data (Sequence SQ416). Then CPU 200 of terminal device 2 displays the obtained image data (new help screen) in the sub-display area on touch panel 208 (Sequence SQ418).

When the user touches any one of positions in the sub-display area displayed on touch panel 208 (Sequence SQ420), information on the touched position is transmitted to CPU 200 of terminal device 2 (Sequence SQ422). CPU 200 of terminal device 2 determines that the position touched by the user is the sub-display area, and the same pieces of processing as those in Sequences SQ408 to SQ418 are repeated.

When the user touches any one of positions in the main display area displayed on touch panel 208 (Sequence SQ430), information on the touched position is transmitted to CPU 200 of terminal device 2 (Sequence SQ432). CPU 200 of terminal device 2 determines that the position touched by the user is the main display area, and transmits the operation command to “return to the operation screen” to MFP 1 (Sequence SQ434). In response to the operation command to “return to the operation screen,” MFP 1 switches the displayed content on operation panel 110 from the help screen to the operation screen (Sequence SQ436).

Based on the relationship between the display position and the size of the displayed main display area, CPU 200 of terminal device 2 converts the position touched by the user into the operation coordinate position indicating which position is touched in the operation screen (Sequence SQ438). CPU 200 of terminal device 2 transmits the operation coordinate position to MFP 1 (Sequence SQ440). When receiving the operation coordinate position from terminal device 2, MFP 1 performs the corresponding setting processing while updating the displayed content on operation panel 110 according to the processing (Sequence SQ442). CPU 200 of terminal device 2 obtains the image data including a new content for replacing (e.g. updated operation screen) on operation panel 110 from MFP 1 (Sequence SQ444), and caches the obtained image data (Sequence SQ446). Then CPU 200 of terminal device 2 displays the obtained image data (e.g. updated operation screen) in the main display area on touch panel 208 (Sequence SQ448).

Thus, in response to the user operation to the sub-display area, CPU 200 of terminal device 2 issues the corresponding operation command to image forming apparatus 1. The operation command includes a command to display the content corresponding to the display area that becomes a target of the user operation on operation panel 110.

<G. Modification>

In the embodiment, by way of example, the user operation to terminal device 2 is always transmitted to MFP 1. In the case that reference information (meta-information) is added to the operation screen and the help screen, which are provided by MFP 1, the screen transition processing can further be simplified and shortened by retaining the meta-information.

That is, CPU 200 of terminal device 2 stores the image data including the operation screen and the image data including the help screen while correlating the pieces of image data with each other, and displays the stored image data illustrating the operation screen without newly obtaining image data including a second help screen from image forming apparatus 1 when a command to display the operation screen is issued and the help screen correlated with the operation screen of the command is already stored.

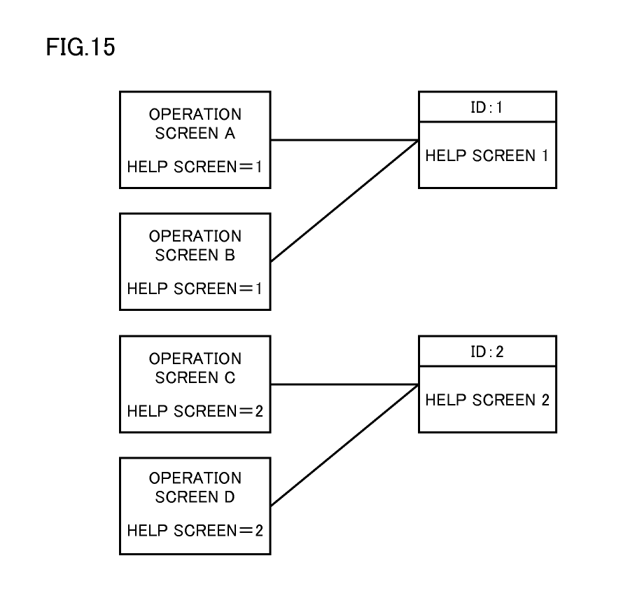

FIG. 15 is a view illustrating a correspondence between the operation screen and the help screen according to a modification according to the embodiment. Referring to FIG. 15, it is assumed that, in addition to the image data, information (for example, help screen ID) assigning the help screen to be referred to is added as information (data) providing each operation screen.

MFP 1 outputs the meta-information to terminal device 2. Terminal device 2 retains the image data output from MFP 1 and the help screen assigned by the meta-information corresponding to the image data while correlating the image data and the meta-information with each other. In the case that the image data output from MFP 1 and the help screen assigned by the meta-information corresponding to the image data are retained while correlated with each other, when the help screen correlated with the operation screen of the transition destination is already retained even if the transition is made from a certain operation screen to another operation screen, a processing time can be shortened without newly obtaining the help screen by reading and using the stored help screen.

A procedure for performing the processing will be described below.

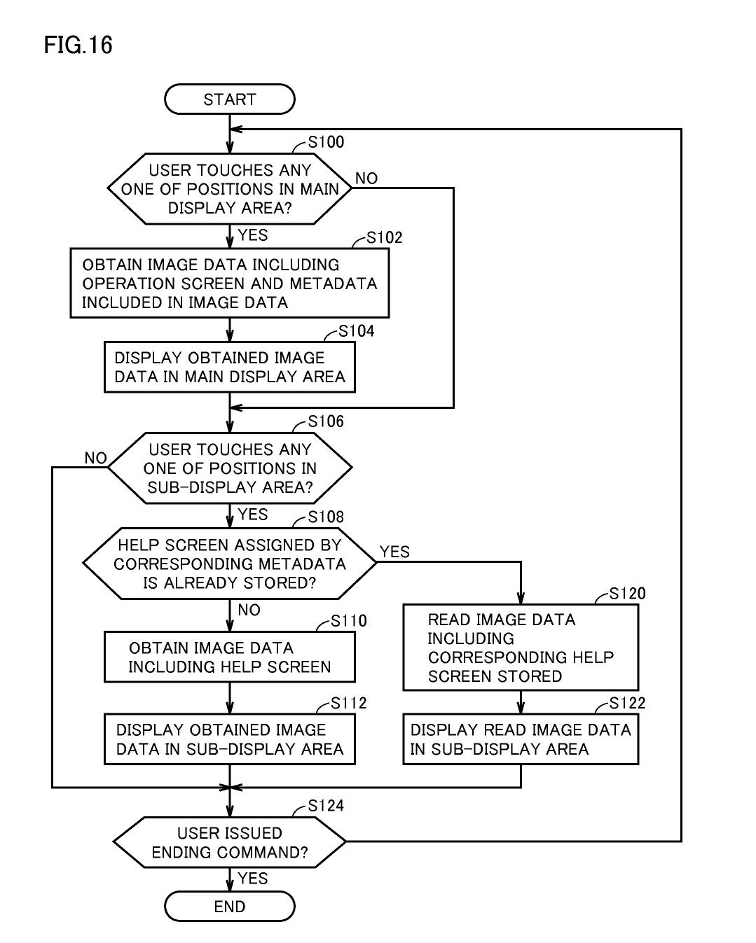

FIG. 16 is a flowchart illustrating a main part of an entire processing procedure in terminal device 2 of the modification according to the embodiment.

Referring to FIG. 16, CPU 200 of terminal device 2 determines whether the user touches any one of positions in the main display area displayed on touch panel 208 (Step S100). When the user touches any one of positions in the main display area displayed on touch panel 208 (YES in Step S100), the image data including the operation screen displayed on operation panel 110 and the metadata included in the image data are obtained from MFP 1 (Step S102). CPU 200 of terminal device 2 displays the obtained image data in the main display area on touch panel 208 (Step S104).

When the user does not touch any one of positions in the main display area displayed on touch panel 208 (NO in Step S100), the pieces of processing in Steps S102 and S104 are skipped.

CPU 200 of terminal device 2 determines whether the user touches any one of positions in the sub-display area displayed on touch panel 208 (Step S106). When the user touches any one of positions in the sub-display area displayed on touch panel 208 (YES in Step S106), CPU 200 of terminal device 2 determines whether the help screen assigned by the corresponding metadata is already stored (Step S108).

When the help screen assigned by the corresponding metadata is not stored (NO in Step S108), CPU 200 of terminal device 2 causes MFP 1 to display the help screen on operation panel 110, and obtains the image data including the help screen to be displayed (Step S110). CPU 200 of terminal device 2 displays the obtained image data in the sub-display area on touch panel 208 (Step S112).

When the help screen assigned by the corresponding metadata is already stored (YES in Sequence SQ108), CPU 200 of terminal device 2 reads the image data including the corresponding help screen stored (Step S120). CPU 200 of terminal device 2 displays the read image data in the sub display area on touch panel 208 (Step S122).

When the user does not touch any one of positions in the sub-display area displayed on touch panel 208 (NO in Step S106), the pieces of processing in Steps S108, S110, S112, S120, and S122 are skipped.

The pieces of processing in Steps S120 and S122 are repeated until the user issues the ending command (Step S124).

<H. Advantage>

In the embodiment, when the multiscreen simultaneous display mode is selected, one of the single screen mode and the multiscreen mode is determined based on the relationship between the image size (resolution) of touch panel 208 and the size (resolution) of the image data displayed on operation panel 110. One of the operation screen and the help screen is automatically displayed in the adequate manner according to the determined mode.

Therefore, according to the embodiment, MFP 1 can remotely be operated on the side of terminal device 2 without changing the processing on the side of MFP 1. Because the change is not necessary on the side of MFP 1, any operation trouble is not generated even if terminal device 2 that can deal with only the single screen mode exists.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A terminal device capable of remotely operating an image forming apparatus including an operation panel, the image forming apparatus being configured to output image data including a content to be displayed on the operation panel, the terminal device comprising:
a display unit;
a determination unit for determining whether a plurality of images can be displayed on the display unit based on first image data output from the image forming apparatus;
a switching unit for issuing a switching command to switch the displayed content on the operation panel to the image forming apparatus in response to the determination that the plurality of images can be displayed, and for obtaining second image data different from the first image data subsequent to the switching command, the second image data being output from the image forming apparatus; and
a controller for displaying the first image data and the second image data on the display unit.

2. The terminal device according to claim 1, wherein the controller is configured to:
display the first image data in a first display area, and display the second image data in a second display area, and
maintain the displayed content on the first or second display area until the first or second image data is newly obtained.

3. The terminal device according to claim 2, further comprising an operation unit for issuing a corresponding operation command to the image forming apparatus in response to a user operation to the first or second display area.

4. The terminal device according to claim 3, wherein the operation command includes a command to display a content corresponding to the display area, which becomes a user operation target, in the operation panel.

5. The terminal device according to claim 1, wherein the controller is configured to:
obtain the second image data even if the plurality of images cannot be displayed, and
display the second image data while overlapping the second image data on the first image data.

6. The terminal device according to claim 1, wherein the controller is configured to:
store the first image data and the second image data while correlating the first image data and the second image data with each other, and
display the stored second image data without newly obtaining second image data from the image forming apparatus, when a command to display the first image data is issued and the second image data correlated with the first image data of the command is already stored.

7. A non-transitory storage medium storing therein a computer-readable program for remotely operating an image forming apparatus including an operation panel, the program, when executed by a computer including a display unit, causing the computer to perform the steps of:
determining whether a plurality of images can be displayed on the display unit based on first image data output from the image forming apparatus, the image forming apparatus being configured to output image data including a content to be displayed on the operation panel to the computer;
issuing a switching command to switch the displayed content on the operation panel to the image forming apparatus in response to the determination that the plurality of images can be displayed;
obtaining second image data different from the first image data subsequent to the switching command, the second image data being output from the image forming apparatus; and
displaying the first image data and the second image data on the display unit.

8. The non-transitory storage medium according to claim 7, wherein the step of displaying includes the steps of:
displaying the first image data in a first display area and displaying the second image data in a second display area; and
maintaining the displayed content on the first or second display area until the first or second image data is newly obtained.

9. The non-transitory storage medium according to claim 8, wherein the program further causes the computer to perform the step of issuing a corresponding operation command to the image forming apparatus in response to a user operation to the first or second display area.

10. The non-transitory storage medium according to claim 9, wherein the operation command includes a command to display a content corresponding to the display area, which becomes a user operation target, in the operation panel.

11. The non-transitory storage medium according to claim 7, wherein the step of displaying includes the step of:
obtaining the second image data even if the plurality of images cannot be displayed and
displaying the second image data while overlapping the second image data on the first image data.

12. The non-transitory storage medium according to claim 7, wherein
the step of displaying includes the steps of:
storing the first image data and the second image data while correlating the first image data and the second image data with each other; and
displaying the stored second image data without newly obtaining second image data from the image forming apparatus, when a command to display the first image data is issued and the second image data correlated with the first image data of the command is already stored.

13. A remote operation system comprising:
an image forming apparatus including an operation panel; and
a terminal device capable of remotely operating the image forming apparatus, wherein
the image forming apparatus is configured to output image data including a content to be displayed on the operation panel, and
the terminal device includes:
a display unit;
a determination unit for determining whether a plurality of images can be displayed on the display unit based on first image data output from the image forming apparatus;
a switching unit for issuing a switching command to switch the displayed content on the operation panel to the image forming apparatus in response to the determination that the plurality of images can be displayed, and for obtaining second image data different from the first image data subsequent to the switching command, the second image data being output from the image forming apparatus; and
a controller for displaying the first image data and the second image data on the display unit.

14. The remote operation system according to claim 13, wherein the controller is configured to:
display the first image data in a first display area, and display the second image data in a second display area, and
maintain the displayed content on the first or second display area until the first or second image data is newly obtained.

15. The remote operation system according to claim 14, further comprising an operation unit for issuing a corresponding operation command to the image forming apparatus in response to a user operation to the first or second display area.

16. The remote operation system according to claim 15, wherein the operation command includes a command to display a content corresponding to the display area, which becomes a user operation target, in the operation panel.

17. The remote operation system according to claim 13, wherein the controller is configured to:
obtain the second image data even if the plurality of images cannot be displayed, and
display the second image data while overlapping the second image data on the first image data.

18. The remote operation system according to claim 13, wherein the controller stores the first image data and the second image data while correlating the first image data and the second image data with each other, and the controller displays the stored second image data without newly acquiring second image data from the image forming apparatus when the correlated second image data is stored in issuing a command to display the first image data.
